(19) United States
(12) Patent Application Publication
(10) Pub. No.: US 2013/0344424 A1
(43) Pub. Date: Dec. 26, 2013

(54) ORGANIC PHOTOCONDUCTORS AND METHODS OF MANUFACTURING THE SAME

(71) Applicants: Krzysztof Nauka, Palo Alto, CA (US); Anthony William McLennan, Concord, CA (US); Hou T. Ng, Campbell, CA (US)

(72) Inventors: Krzysztof Nauka, Palo Alto, CA (US); Anthony William McLennan, Concord, CA (US); Hou T. Ng, Campbell, CA (US)

(21) Appl. No.: 13/530,701

(22) Filed: Jun. 22, 2012

(51) Int. Cl. G03G 5/043

(52) U.S. Cl. 430/57.1; 430/132; 430/130

(57) ABSTRACT

Organic photoconductors and methods of manufacturing the same are disclosed. An example method to manufacture an organic photoconductor involves applying a liquid solution to a surface of a cylindrically-shaped substrate while rotating the substrate about its axis, the substrate comprising a surface layer and the liquid solution comprising a matrix polymer species and a dopant species dissolved in a solvent. The example method further involves rotating the substrate while the solvent evaporates to provide a substantially evenly distributed seamless residue film comprising the matrix polymer species and the dopant species, and cross-linking the matrix polymer species of the residue film.

### BACKGROUND

An organic photoconductor (OPC) is one of the components of an electrophotographic (or xerographic) process employed in many printing and/or photocopying devices. The lifetime of known organic photoconductors are limited by the degradation of print quality as defects arise within the surface of the OPC as a result of chemical, electrical and/or mechanical interactions between the OPC and the printing environment. As a result, an OPC is one of the most frequently replaced components of a printing device, thereby resulting in increased costs of using such printing devices.

Efforts have been made to fabricate cylindrical-shaped OPCs by sputtering or evaporating selected organic compounds either directly on the surface of a drum form usually made of metal, or on a rigid cylindrical sleeve subsequently mounted to the drum. However, such efforts have yielded poor quality photoconductors with mechanically weak, readily cracking, rough surfaces.

### BRIEF DESCRIPTION OF THE DRAWINGS

FIG. 1 is a schematic diagram of an example apparatus that employs an example OPC in accordance with the teachings disclosed herein.

FIG. 2 is a cross-section of a portion of an example implementation of the OPC layered surface of the OPC of FIG. 1.

FIG. 3 is a cross-section of a portion of another example implementation of the OPC layered surface of the OPC of FIG. 1.

FIG. 4 is an example configuration to manufacture a seamless protective coating for the example OPC of FIG. 1.

FIG. 5 is another example configuration to manufacture a seamless protective coating for the example OPC of FIG. 1.

FIG. 6 is a flow diagram representative of an example method to manufacture the example OPC of FIG. 1.

### DETAILED DESCRIPTION

The shortcomings of known OPCs are particularly critical in the case of high speed digital printing that seeks to reduce printing costs in order to successfully compete with analog printing. Previous attempts of replacing an OPC with an inorganic photoconductor or coating the OPC with a hard inorganic protective layer have failed due to excessive cost, manufacturing problems, and/or poor performance of the resulting product.

Furthermore, many known OPCs are manufactured from surface layers formed as a flexible flat sheet and subsequently wound or wrapped around a cylindrical drum. Such an approach results in the presence of a seam along the surface of the OPC where the sheet ends meet. A seam may lead to limits on page length in printing, and/or re-printing of areas surrounding the seam to achieve a desired color efficacy. Furthermore, an OPC seam presents significant challenges for web-fed printing applications. Additionally, the process of wrapping a flat sheet of photoconductive material around a drum creates stress and/or strain within the photoconductive material that may undesirably affect the mechanical properties of the materials to become more susceptible to damage when placed in operation.

An organic coating for an OPC formed of damage resistant cross-linkable polymers and short chain polymeric charge transfer moieties (CTMs) can significantly increase the damage resistance and durability (i.e., useful life) of the OPC while maintaining high print quality. For example, controlled experimental scratch tests performed using flat sheets of the organic coating wrapped around an OPC drum show improvements of the mechanical damage resistance of approximately five to ten times over known OPCs while substantially maintaining print performance. However, while such a coating improves the durability of OPCs, using flexible a flat sheet of photoconductive material as the coating around a drum results in an undesirable seam and potentially undesirable stresses and/or strains in the surface coating. Example methods to manufacture seamless OPCs are disclosed herein which overcome these and other problems by cross-linking a matrix polymer species with embedded CTMs directly on the surface of a cylindrical OPC. In some examples, the CTMs include small molecules instead of, or in addition to, the short chain polymers described above.

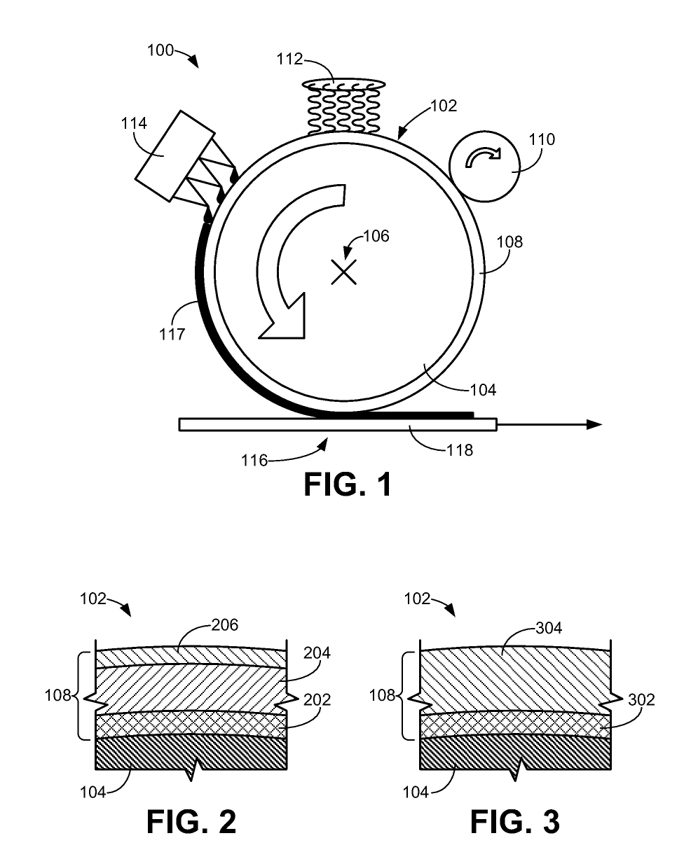

FIG. 1 is a schematic diagram of an example apparatus 100 constructed in accordance with the teachings of this disclosure. The example apparatus 100 employs an example OPC 102. The example OPC 102 comprises an example OPC layered surface 108 surrounding a drum form 104 that is rotatable about an axis 106.

The drum 104 of the illustrated example comprises a conductive material (e.g., aluminum). The conductive material serves as a substrate upon which the OPC layered surface 108 resides and provides an electrical path to ground. In some examples, the conductive substrate is incorporated directly into the drum 104. In other examples, the conductive substrate comprises a rigid cylindrical sleeve which is placed around the drum form 104. The layered surface 108 of the illustrated example includes a bottom charge generation layer (CGL) and a top charge transport layer (CTL). In the illustrated example, the layered surface 108 also comprises a protective layer or coating as will be described in greater detail below.

In the illustrated example, as the OPC 102 rotates during a printing process, it passes through several stations, including a charging station 110, an exposure or image-forming station 112, a development station 114, and a transfer station 116. At the charging station 110 of the illustrated example, a negative electrostatic charge is uniformly distributed over the surface of the OPC 102 and maintained as a result of the electrical characteristics of the OPC layered surface 108. In some examples, the charging is done by a corona charger. In other examples, the charging is accomplished via a charge roller.

At the exposure station 112 of the illustrated example, a document to be printed (e.g., electrophotographed), or an image of the document formed on a screen, is illuminated and either passed over a lens or is scanned by a moving light and lens, such that its image is projected onto and synchronized with the surface of the rotating OPC 102. Light from the projected image passes through the CTL (which is substantially transparent) and strikes the CGL resulting in the generation of free electrons and holes. Electrons are collected by the electrical ground of the photoreceptor (e.g., via the drum 104) and holes are driven by an applied electrical field or bias towards the top surface of the CTL. The CTL of the illustrated example is formed of a non-conductive organic material (e.g., a polymer) matrix with a dopant species (referred to as charge transport moieties (CTMs)) embedded within the non-conductive matrix. The CTMs within the CTL enable the hole transport towards the surface. At the surface the holes are used to neutralize negative surface ions deposited via the charging station 110. Accordingly, in the illustrated example, the area(s) where the document, or document image, contains content (e.g., text, pictures, etc.) the corresponding area(s) of the OPC 102 remains unlit. As a result, these area(s) do not pass light through the CTL to strike the CGL and, thus, do not generate an electrical charge to neutralize the electrostatic charge at such location(s). In contrast, the area(s) where the document, or document image, contains no content, the OPC 102 is illuminated and the electrostatic charge at the corresponding locations is dissipated by the holes as explained above. As a result, the area(s) of electrostatic charge remaining on the example OPC 102 of the illustrated example form a “latent” image that is a negative of the original document, or document image. In some examples, a reversed arrangement is employed in which a positive electrostatic charge is deposited on the surface of the OPC 102, and then selectively dissipated by photogenerated electrons rather than holes.

At the development station 114 of the illustrated example, the OPC 102 is presented with toner 117 such as black or colored electro-ink and/or any other marking particles. The toner 117 is electrically charged complementarily to the electrostatic charge on the OPC layered surface 108 to be attracted to the areas on the OPC 102 corresponding to the latent image of the document.

At the transfer station 116 of the illustrated example, the toner 117 on the OPC 102 is transferred to a print medium 118 (e.g., paper) that is moving relative to the speed and direction of the rotating OPC 102. In some examples, the polarities of this process may be reversed depending on the initial document or image being copied (e.g., photocopying a white on black microfilm to black on white paper). Following the toner transfer, the example OPC 102 is prepared for a new imaging cycle (e.g., by scraping off any remaining toner 117 via a doctor blade).

To achieve high quality printing using an electrophotographic process, the example OPC layered surface 108 of FIG. 1 has very uniform characteristics over its entire area, such as: coating uniformity, dark conductivity, and photoconductivity. During each print cycle, the example OPC layered surface 108 is subjected to a number of electrochemical and mechanical processes that can affect the desired uniformity of one or more characteristics of the OPC layered surface 108. Examples of such processes include corrosive ozone and acid treatments from the corona charging, abrasive mechanical treatments from toner development, toner transfer to a paper, and doctor blade cleaning of the OPC 102, and/or contact with a charge roller. Such processes may potentially cause removal of the top part of an OPC layered surface, mechanical damage (e.g., scratching), and/or local cracking of the CTL. In the case of liquid electrophotography, these affects can be exacerbated by interactions between the ink solvent (usually a non-polar, isoparaffinic-based mixture) and the polymer constituting the CTL. For instance, the solvent may penetrate into the CTL through openings caused by the mechanically damaged surface and cause local swelling of the CTL as the solvent and the CTL react. Such CTL damage would degrade print quality, causing the OPC to be frequently replaced. Frequent photoconductor replacement can have a negative impact on the cost of the printing process, which is particularly important for high speed and/or large volume printing applications, as in the case of digital commercial printers.

FIG. 2 is a cross-section of a portion of an example implementation of the OPC layered surface 108 of the OPC 102 of FIG. 1. As shown in the illustrated example of FIG. 2, the example implementation of the OPC layered surface 108 includes a charge generation layer (CGL) 202 and a charge transport layer (CTL) 204 on the surface of the drum 104. The CGL 202 and the CTL 204 function as explained above to generate and transport electrical charge carriers as described above. In addition to the CGL 202 and the CTL 204, the OPC layered surface 108 of the illustrated example includes a protective film, layer, or coating 206 that is on top of the CTL 204. This protective layer 206 possesses substantially similar electrical characteristics to the CTL 204 but has superior resistance to damage during a printing process. For example, the coating 206 of the illustrated example is formed of a material having a higher scratch resistance than the CTL 204 to increase the durability of the OPC 102 against surface mechanical damage encountered during the printing process. In some examples, the coating 206 includes “hard” inorganic nanoparticles (e.g., silica, Ti-oxide, etc.) to further increase the scratch resistance of the coating 206. Additionally or alternatively, the materials used to form the coating 206 may be such that they do not react with the solvents used during the printing process to increase the resistance of the OPC 102 to chemical damage.

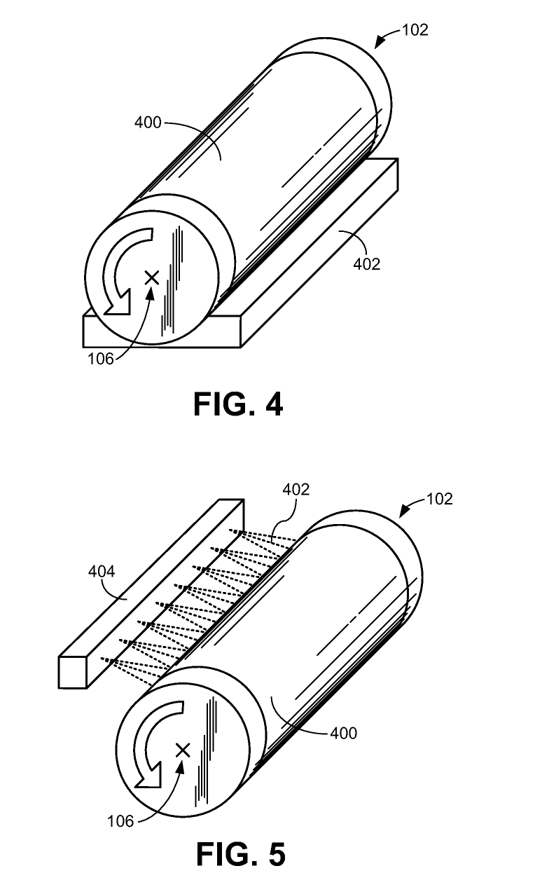

FIG. 3 is a cross-section of a portion of another example implementation of the OPC layered surface 108 of the OPC 102 of FIG. 1. In the illustrated example of FIG. 3, the example OPC layered surface 108 includes a CGL 302 on the surface of the drum 104. The CGL 302 of the illustrated example functions to generate free electrons and holes in the same manner as described above. The example OPC layered surface 108 of FIG. 3 also comprises a coating 304 with similar damage resistance properties as the coating 206 of FIG. 2 and similar electrical properties as the CTL 204 of FIG. 2. However, in the illustrated example of FIG. 3, the OPC layered surface 108 does not include a CTL independent of the coating 304. Rather, the coating 304 in FIG. 3 serves as both the CTL (to transport electron holes to the surface of the OPC 102) and as a damage resistant protective layer for the OPC 102. Thus, the example coating 304 of FIG. 3 may be referred to as an integrated CTL/protective coating. While in the illustrated examples of FIGS. 2 and 3, the thickness of the coating 304 of FIG. 3 is thicker than the coating 206 of FIG. 2, the integrated CTL/protective coating 304 of FIG. 3 may be of any suitable thickness (e.g., substantially the same thickness as the CTL 204 of FIG. 2). Furthermore, the integrated CTL/protective coating 304 of FIG. 3 functions in substantially the same manner as the separate CTL 204 and protective coating 206 layer of FIG. 2. Accordingly, the method of applying a protective coating disclosed in greater detail below may be implemented on an existing and/or complete OPC (e.g., by applying the protective coating 206 as shown in FIG. 2) or may be incorporated into the manufacturing of a new OPC to include a damage resistant integrated CTL/protective coating (e.g., FIG. 3).

In the illustrated examples of FIGS. 2 and/or 3, the protective coatings 206, 304 comprise a damage resistant polymer matrix with substantially uniformly embedded CTMs (serving as a dopant). The strength of the example protective coatings 206, 304 are, at least in part, achieved via in-situ cross-linking of the polymer after being applied to the surface of the OPC 102 as will be described in greater detail below in connection with FIGS. 4 and 5. The protective coatings 206, 304, of the illustrated examples, are created using a solution of monomers or oligomers (herein referred to as a “matrix polymer species”) and short chain polymeric CTMs (herein referred to as a “dopant species”) mixed within a solvent. In some examples, the dopant species is a polymeric dopant having a weight average molecular weight of less than 200,000. In some examples, the solution comprises small molecule CTMs (e.g., Alq3 (aluminum 8-hydroxyquinoline), CuPc (copper phthalocyanine), rubrene (tetraphenyl tetracene, NBP (biphenyl diamine), etc.) instead of, or in addition to, the short chain polymeric CTMs. However, using short chain polymeric dopant species provides certain advantages over small molecule dopants that are commonly used in known OPCs. For example, known OPCs doped with small molecules require a concentration of the dopant in the range of approximately 30% to 50% (by weight) to achieve the desired electrical conduction. This relatively high concentration may limit the structure of the cross-linked coating, thereby reducing its mechanical strength. In contrast, the use of short chain polymers as the dopant species, as described herein, achieves similar electrical properties with a dopant concentration of less than 10% (by weight) and, then, do not suffer from the mechanical strength degradation described above. Furthermore, polymeric CTMs exhibit better structural conformity by intertwining with the cross-linked matrix polymer species, thereby largely maintaining, or even enhancing, the matrix polymer. Additionally, in some examples, the solution includes other cross-linkable non-conductive moieties that link with the matrix polymer species to provide additional mechanical strength. In some such examples, the cross-linking process produces a composite material comprising the original matrix polymer, the additional cross-linked non-conductive polymer, and the cross-linked dopant species.

In some examples, the solution also includes other additives or species, such as, for example, an initiator and/or cross-linker to facilitate the cross-linking of the matrix polymer species. Further, in some examples, the solution contains additives such as for example, wetting and/or viscosity-controlling agents to provide the desired rheological properties of the material, and/or other auxiliary species and/or additives to provide other desired properties to the material (e.g., hard inorganic nanoparticles to increase resistance against mechanical damage).

In the illustrated examples, the solvent used as the base for the solution is to dissolve both the matrix polymer species and the dopant species to provide a substantially uniform dispersion of the dopant species and other moieties or auxiliary additives within the solution. For example, if the solvent is an alcohol (e.g., isopropyl alcohol), the matrix polymer species may be a polyimide while the dopant species may be a polyvinylcarbazole (to transport holes) or a polythiophene (to transport electrons). This and other examples of matrix polymer species and dopant species with a corresponding solvent are outlined in Table 1.

TABLE 1
Solvents and Corresponding Matrix
Polymer Species and Dopant Species

| | Matrix Polymer | Dopant Species | |
|---|---|---|---|
| Solvent | Species | Hole | Electron |
| Alcohol | Polyimides | Polyvinylcarbazole | Polythiophene |
| (e.g., IPA) | | | |
| Furane | Polyacrylates | Polyvinylnaphthalene | Polyfluorene |
| Toluene | Polymethacrylates | Polymethylamine | PCBTDPP |
| Chloroform | Polyamides | Polyfluorene | Poly- |
| | | | phenylinevinylene |
| Water | Polycarbones | Polythiophene | Polyhexythiophene |

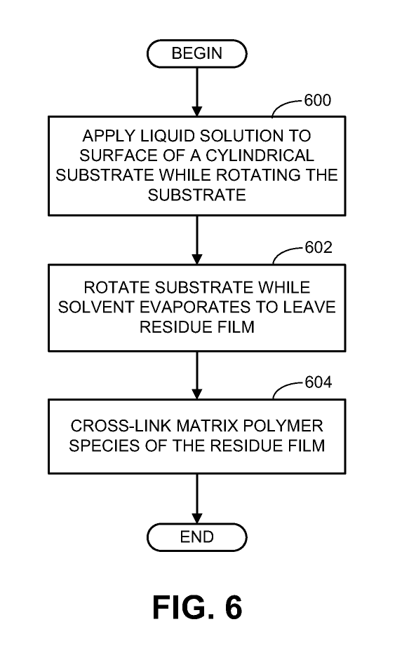

Furthermore, in the illustrated examples, the solvent is inert or non-reactive with the material of the layer beneath the coatings 206, 304. That is, in the illustrated examples, the solvent used in the solution to form the coating 206 of FIG. 2 does not react with the CTL 204 of FIG. 2 and the solvent used in the solution to form the coating 304 of FIG. 6 does not react with the CGL 302 of FIG. 3. In this manner, the prepared solution may be applied to the surface of the corresponding OPC 102, without damaging the surface. However, in some examples, the solvent may be reactive with the lower layers, thereby enabling the coatings 206, 304 to partially mix with the corresponding lower layers if it is so desired.

As previously described, in known methods of manufacturing OPC drums with a durable coating, the structured photoconductive layers and/or the coating are formed as flat sheets and subsequently wrapped around a cylindrical drum. The result is an OPC with a seam that presents limitations to its use in certain printing applications. However, in addition to the limitations mentioned above, manufacturing flat sheets of photoconductive layers presents several other challenges. For example, known manufacturing processes for the photoconductive layers of an OPC are limited in their ability to form thin layers, thereby resulting in greater quantities of material used to make the OPC, and increasing costs of production. Additionally, known methods of manufacturing such flat sheets of desired photoconductive layers are limited in how consistent and/or evenly distributed the thickness of the sheets are over their surface area thereby resulting in more uneven OPCs and lowering the quality of the resulting printing. Such obstacles are overcome by applying the coating to an OPC in accordance with the teachings disclosed herein.

FIGS. 4 and 5 illustrate example methods to manufacture a seamless protective coating for the example OPC 102 of FIG. 1. FIGS. 4 and 5 illustrate example methods of applying a liquid film 400 of a solution 402 containing the materials (e.g., matrix polymer species, dopant species, etc.) of the coatings 206, 304 described above to the surface of the OPC 102 of FIG. 1. In the illustrated example of FIG. 4, at least a portion of the OPC 102 is dipped into the solution 402. The entire peripheral surface of the OPC 102 is then covered with the solution 402 by rotating the OPC 102 about the axis 106.

In the example shown in FIG. 5, a sprayer 404 sprays the solution 402 onto the OPC 102 as it is rotated about its axis 106 so as to completely cover the surface of the OPC 102. In other examples, the solution 402 may be applied to cover the OPC 102 with the liquid film 400 via a secondary transfer roller or brush and/or via any other suitable deposition technology.

Once the liquid film 400 covers the entire peripheral surface of the OPC 102, the solvent is allowed to evaporate. However, unlike known methods where the solvent evaporates while the solution rests on a flat surface to form flat sheets, in the illustrated examples, the solvent evaporates as the OPC 102 continues to rotate. Consequently, the resulting residue containing the matrix polymer species, the dopant species, and any other additives is distributed with a substantially uniform thickness about the OPC 102 without creating seams (e.g., a seamless protective coating is formed). The speed of rotation, along with other factors based on the properties of the materials involved (e.g., concentrations and types of matrix polymer species, dopant species, and any other additives in the solution), can be used to substantially control the thickness of the protective coating. In some examples, the thickness of the protective coating ranges from approximately 0.1 μm to approximately 20 μm. In other examples, the thickness ranges from approximately 0.2 μm to approximately 2 μm.

In the illustrated examples, after the solvent has evaporated, the residue is heated and/or exposed to UV irradiation to cross-link the matrix polymer species along with any other polymerizable species contained in the residue (e.g., a cross-linker). In some thermally activated examples, the annealing temperature of the matrix polymer species ranges from approximately 70 degrees Celsius to 150 degrees Celsius. In some examples, the temperature is maintained in the range of approximately 80 degrees Celsius to approximately 100 degrees Celsius. Regardless of the activation method, in some examples, the OPC 102 is rotated during the polymerization process to maintain greater uniformity in the cross-linking of the materials. Such rotation may be especially beneficial when a directional heat and/or UV source is used. Furthermore, the speed of rotation in such situations, along with controlling other factors in the cross-linking process (e.g., varying time, UV exposure and/or temperature), can be used to tune the mechanical strength of the protective layers 206, 304 of the illustrated examples.

Fabricating OPCs with coatings in this manner provide OPCs that are both durable and do not have seams, thereby overcoming challenges faced in the prior art. In particular, a seamless OPC has no limitation on page length and can, therefore, be adapted to web-fed printing processes. Additionally, seamless printing allows for increased speed in printing and, thus, reduced cost. Furthermore, the matrix polymer species are cross-linked after being placed on the round surface of the OPC such that no internal stress or strain is present, thereby increasing the mechanical strength of the coating. Further still, the use of organic photoconductive materials enables recycling and/or reusing the drum form by removing old and/or damaged photoconductive materials (e.g., by dissolving them in an organic solvent) to prep the drum for the reapplication of a new layered surface using the methods described herein.

FIG. 6 is a flow diagram illustrating an example method to manufacture the example OPC 102 of FIGS. 1-3. Although the example method is described with reference to FIG. 6, other processes of implementing the example method may be used. For example, the order of execution of the blocks may be changed, and/or some of the blocks described may be changed, eliminated, sub-divided, or combined.

The example process of FIG. 6 includes applying a liquid solution to the surface of a cylindrical substrate while rotating the substrate (block 600). In some examples the substrate may be a completed OPC (e.g., the example OPC 102 of FIG. 2) with a drum (e.g., the drum 104 of FIG. 2), a CGL (e.g., the CGL 202 of FIG. 2), and a CTL (e.g., the CTL 204 of FIG. 2). In other examples, the substrate may include a drum (e.g., the drum 104 of FIG. 3) and a CGL (e.g., the CGL 302 of FIG. 3). In such examples, the protective coating also serves as the CTL to complete the manufacturing of the resulting OPC.

The liquid solution applied to the surface of the substrate in the example of FIG. 6 includes a solvent containing a matrix polymer species and a dopant species dissolved therein that are to serve as the basis for a protective coating for the substrate. In some examples other additives are included in the solution such as, for example, one or more of an initiator or activator, a cross-linker, a wetting agent, a viscosity controlling agent, hard inorganic nanoparticles, or any other desired additive. By varying the concentration and/or types of materials used for any of the above mentioned components of the solution, the mechanical properties and/or the electrical properties of the resulting protective coating may be controlled. The liquid solution may be applied in the example process using any suitable method, including any of (1) dipping a portion of the substrate into the liquid solution, (2) spraying the substrate with the solution, or (3) applying the solution with a brush or roller.

Once the liquid solution has been applied to the substrate, the example process of FIG. 6 includes rotating the substrate while the solvent of the solution evaporates (block 602). The rotation of the substrate during the evaporation of the solvent provides for a substantially evenly distributed residue film of the matrix polymer species, dopant species, and any other auxiliary additives around the entire peripheral surface of the substrate. Furthermore, in some examples, the speed of rotation is adjusted to control the thickness of the residue film. For example, a faster speed of rotation results in a thinner film whereas a slower speed of rotation results in a thicker film. The particular speed of rotation used to achieve a desired thickness depends upon a number of factors pertaining to the coating conditions including, surface preparation of the surface to be coated, viscosity of the liquid solution, and the size (e.g., radius) of the substrate,

After the solvent has evaporated, the example process of FIG. 6 includes cross-linking the matrix polymer species of the residue film (block 604). The cross-linking in the example process may be accomplished by either applying heat to the residue and/or by applying UV irradiation; depending upon the initiator(s) or activator(s) within the residue film. In some examples, the substrate (e.g., the drum 104) is rotated during the cross-linking process to provide consistent mechanical properties across the entire surface area of the protective coating. Once the matrix polymer species has been cross-linked the example process of FIG. 6 ends.

Although the foregoing description has described methods of applying a protective coating to organic photoconductors, the teachings disclosed herein may be suitably adapted to applying a coating to an inorganic photoconductor or an OPC with one or more layers of inorganic materials on its surface. Furthermore, although certain example methods and apparatus have been described herein, the scope of coverage of this patent is not limited thereto. On the contrary, this patent covers all methods, apparatus and articles of manufacture fairly falling within the scope of the claims of this patent either literally or under the doctrine of equivalents.

1. A method to manufacture an organic photoconductor, comprising:
applying a liquid solution to a surface of a cylindrically-shaped substrate while rotating the substrate about its axis, the substrate comprising a surface layer and the liquid solution comprising a matrix polymer species and a dopant species dissolved in a solvent;
rotating the substrate while the solvent evaporates to provide a substantially evenly distributed seamless residue film comprising the matrix polymer species and the dopant species; and
cross-linking the matrix polymer species of the residue film.

2. A method as described in claim 1, wherein applying the liquid solution comprises any of dipping a portion of the rotating substrate into the liquid solution, spraying the liquid solution onto the rotating substrate, brushing the liquid solution onto the rotating substrate, or rolling the liquid solution onto the rotating substrate via a secondary transfer roller.

3. A method as described in claim 1, wherein the substrate comprises a rigid sleeve to be mounted to a cylindrical drum.

4. A method as described in claim 1, wherein the surface layer comprises a charge generation layer.

5. A method as described in claim 4, wherein the surface layer further comprises a charge transport layer on top of the charge generation layer.

6. A method as described in claim 1, wherein the matrix polymer species is at least one of monomers or oligomers.

7. A method as described in claim 1, wherein the dopant species comprises at least one of short chain polymers or small molecules.

8. A method as described in claim 1, wherein the liquid solution further comprises one or more of an initiator or activator, a cross-linker, a wetting agent, a viscosity controlling agent, or hard inorganic nanoparticles.

9. A method as described in claim 1, further comprising controlling a speed of rotation of the substrate to obtain a desired thickness for the residue film.

10. A method as described in claim 1, wherein cross-linking is accomplished by at least one of ultraviolet exposure or thermal treatment.

11. An organic photoconductor, comprising:
a cylindrically-shaped conductive substrate;
a charge generation layer on the conductive substrate;
a charge transport layer on the charge generation layer; and
a seamless protective coating formed via in-situ cross-linking of a matrix polymer species on the charge transport layer, the matrix polymer species having a dopant species substantially uniformly distributed therein while rotating the substrate.

12. An organic photoconducter as described in claim 11, wherein the matrix polymer species is at least one of monomers or oligomers and wherein the dopant species comprises at least one of short chain polymers or small molecules.

13. A method to manufacture an organic photoconductor, comprising:
while rotating the photoconductor about its axis:
applying a liquid solution to a surface of the photoconductor to substantially evenly distribute a protective coating on the photoconductor, the liquid solution comprising a matrix polymer species and a dopant species in a solvent;
allowing the solvent to evaporate while retaining at least some of the matrix polymer species and the dopant species; and
cross-linking the matrix polymer species to increase the durability of the protective coating.

14. A method as described in claim 13, wherein the liquid solution further comprises a non-conductive polymer to be cross-linked with the matrix polymer species.

15. A method as described in claim 13, wherein the photoconductor comprises an inorganic photoconductive layer.
